(19) United States
(12) Patent Application Publication
(10) Pub. No.: US 2003/0091123 A1
(43) Pub. Date: May 15, 2003

(54) Method of clipping signal comprising a plurality of carriers transmitted by the same non-linear amplifier

(75) Inventor: Luc Dartois, Carrieres Sous Poissy (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: EVOLIUM S.A.S.

(21) Appl. No.: 10/290,217

(22) Filed: Nov. 8, 2002

(30) Foreign Application Priority Data
Nov. 12, 2001 (FR) 01 14 602

(51) Int. Cl. H04K 1/02; H04L 25/03; H04L 25/49; H04L 27/28; H04K 1/10

(52) U.S. Cl. 375/297; 375/260

(57) ABSTRACT

In a method of transmitting more than one carrier using the same power amplifier associated with a linearization arrangement, a composite signal comprising the carriers is clipped before it is applied to the input of the amplifier in order to limit the ratio of the peak power to the average power of the signal to be transmitted. Each carrier is clipped individually and the clipping power density for each carrier is a function of its power.

### CROSS-REFERENCE TO RELATED APPLICATIONS

This application is based on French Patent Application No. 01 14 602 filed Dec. 11, 2001, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of transmitting telecommunication signals using a power amplifier adapted to amplify simultaneously a plurality of signals modulating different carriers. It relates more particularly to a method of the above type in which, to optimize the efficiency of the amplifier, the composite signal comprising signals modulating a plurality of carriers is clipped upstream of the amplifier.

The invention also relates to the application of the above kind of method to a radio transmitter, a base station of a telecommunication system including a radio transmitter, and a mobile telephone network including radio transmitters.

2. Description of the Prior Art

Amplifiers are electronic components which generally exhibit nonlinear behavior, meaning that the output signal is often distorted compared to the input signal. For this reason telecommunication systems include means for linearizing the amplifiers. The method most widely used consists in applying predistortion to the signals upstream of the amplifier input, the predistortion being such that a signal is obtained at the output of the amplifier which faithfully represents the input signal before the predistortion is applied. The predistortion can be digital or analog.

Another prior art method of linearizing amplifiers consists in comparing the amplifier input signal to its output signal, the comparison providing an error signal which is combined, in the opposite phase, with the output signal so that the combined signal is a faithful representation of the input signal.

Moreover, an amplifier used in a transmission system must have the highest possible efficiency to limit power consumption and the dimensions of the amplifier. The efficiency is the ratio between the power of the output signal and the total power consumed by the amplifier.

However, high efficiency is incompatible with a high dynamic range of the input signal. This is because the output signals have a limit value or saturation value. Whatever the value of the input signal, the output signal cannot exceed this limit value. It is therefore clear that the efficiency decreases when the input signals exceed the value beyond which the amplifier is saturated. Furthermore, the amplifier has a linear behavior, with constant gain, for the weakest input signals, and a non-linear behavior when the output signals increase toward saturation, the gain decreasing as the output power increases. Thus an amplifier of the above kind is generally rated so that the saturation power corresponds to the maximum peak or output signal peak and the average output power is in the linear region of the amplifier. The ratio, which is expressed in dB, between the saturation power of the amplifier and its average operating power constitutes a power margin for the amplifier known as its “backoff”. An amplifier having a power margin in dB equal to the ratio of the peak power of the input signal to the average power of the input signal is usually chosen. This ratio is generally referred to as the peak to average ratio (PAR). The higher the PAR, the lower the efficiency of the amplifier.

Increasing the efficiency of amplifiers by applying a clipping method which consists in limiting the amplitude of the signals at the input of the amplifier to a maximum value is known in the art. The limit (or threshold) value, or clipping radius, is determined as a function of the most unfavorable (“worst case scenario”) case of signals to be transmitted by the transmission system of which the amplifier is part, i.e. as a function of the greatest possible ratio between the peak power and the average power of that signal.

The limit value must be chosen accurately to minimize induced interference affecting the quality of the signal at the amplifier input. This is because, like any form of non-linearity, clipping causes distortion of the signal, in addition to attenuation. What is more, the spectrum of the clipping must be controlled in order not to interfere with the spectral characteristic of the signal to be amplified. The spectral characteristic must remain better than (preferably by an order of magnitude) the characteristic obtained with the residual defects of the linearized amplifier.

The distortion and attenuation defects must further conform to the quality and fidelity constraints of the transmission system, which are often defined by the corresponding radio standard. In the UMTS standard, for example, these constraints are defined by 3GPP recommendations TS 25-104 and TS 25-141.

The predistortion parameters, bias, voltage and rating of the power amplifier are generally chosen to obtain a maximum efficiency for a maximum transmitted power. Thus the efficiency is not the optimum for low powers. This is because, at low power, the efficiency of the amplifier is low because its static consumption (because of the bias current) dominates over the dynamic power serving to amplify the signal.

Clipping produces spuriae outside the transmitted frequency band, which is generally not allowed by the standards. It is possible to limit this effect, for example by using the technique described in PCT application WO9965172 which, by means of progressive clipping, brings the spectral error due to clipping back into the wanted transmitted band.

However, it is found that, regardless of the implementation, the distortion introduced when a plurality of modulated carriers is transmitted simultaneously varies according to the activity (or the amplitude) of each of the carriers. In particular, the distortion is greatest for the weakest carriers. Clipping threshold and PAR reduction are limited by the power contrast between the carriers.

The invention eliminates this drawback.

To minimize the distortion of each carrier transmitted, the method according to the invention determines the instantaneous power of each modulated carrier and each of them is assigned a clipping power spectral density that depends on that instantaneous power.

The clipping noise of each modulated carrier can therefore be optimized and the distortion or errors can be distributed in a controlled and adaptive manner over all of the carriers. Consequently, the total clipping threshold can be reduced.

Thus the average clipping distortion power is not the same for all the carriers. The overall characteristic of the filter ideally corresponds to the instantaneous spectral characteristic of the signal. The filter characteristic can nevertheless be simpler than that of the multicarrier composite signal to be clipped. For example, the same clipping power spectral density can be adopted for all the carriers except for that with the lowest power, for which the density is lower.

The power of each carrier is preferably determined sufficiently frequently to adapt to the power variations of each carrier. For example, it is determined for each symbol or at least for each time slot in the case of CDMA or UMTS transmission.

Although the amplifier is rated for the situation in which all the carriers are of maximum power, the method according to the invention minimizes distortion in the event of a high contrast between carriers.

In one embodiment, the filter characteristic is chosen so that the attenuation is lower in the guard bands between carriers. These bands can therefore be used to absorb distortion.

### SUMMARY OF THE INVENTION

The invention provides a method of transmitting a plurality of carriers using the same power amplifier associated with linearization means, in which method a composite signal comprising the plurality of carriers is clipped before it is applied to the input of the amplifier in order to limit the ratio of the peak power to the average power of the signal to be transmitted, each carrier is clipped individually, and the clipping power density for each carrier is a function of its power.

The clipping is preferably effected by adaptive filtering with a spectral characteristic that reproduces the spectrum of the signal to be transmitted.

In one embodiment there is lower attenuation between adjacent bands.

In one embodiment the carrier with the lowest power is determined, that carrier is allocated a first clipping spectral density threshold, and the other carriers are allocated a second clipping spectral density threshold higher than the first.

The clipping spectral density levels are chosen from sets previously stored in memory, for example, in particular sets of filters.

In one embodiment the signals to be transmitted modulating the carriers are CDMA signals and in this case the power of each carrier is estimated over at least one symbol during each time slot. Each carrier is estimated over the longest symbol of the time slot, for example.

The power can be estimated for each coding sample of the symbol for which the estimate is effected. In another embodiment the carrier bands transmit time division multiplexed signals.

One embodiment includes gain compensation to obtain at the input of the amplifier a signal having practically the same amplitude as the composite signal despite gain variations caused by the clipping. The carriers are in adjacent bands, for example.

The invention also includes application of a method as defined hereinabove to a base station of a telecommunication system.

The invention further includes application of a method as defined hereinabove to a terminal of a telecommunication system.

Other features and advantages of the invention will become apparent in the course of the description with reference to the accompanying drawings of embodiments of the invention.

### BRIEF DESCRIPTION OF THE DRAWINGS

FIG. 1 is a diagram showing one embodiment of a method according to the invention.

FIG. 1a is a diagram similar to that of FIG. 1 for a different embodiment of the invention.

FIG. 2 is a diagram of a base station using a method according to the invention.

### DETAILED DESCRIPTION OF THE PREFERRED EMBODIMENTS

In the example described hereinafter, reference is made to a UMTS telecommunication system in which base stations transmit CDMA signals to terminals.

The CDMA transmission principle is, briefly, as follows: the signals are transmitted in the form of symbols and each symbol comprises a number of samples (4 to 128 or 256 samples) referred to as “chips” and representing a code. A base station sends simultaneously to a plurality of terminals. All of the terminals receive all of the signals sent by the base station, but as each terminal is allocated a particular code, different from that of the other terminals, and as the codes are orthogonal, a terminal can efficiently isolate signals conforming to the particular code allocated to it.

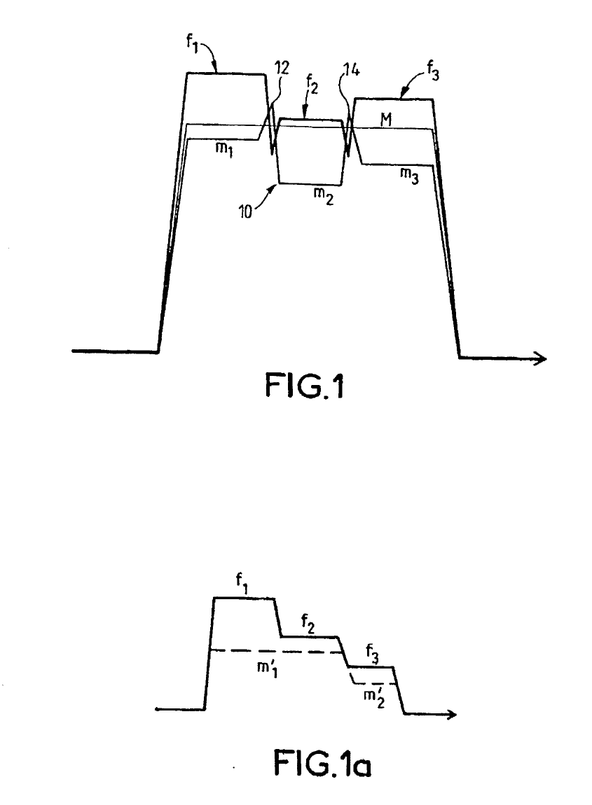

The UMTS telecommunication system uses a plurality of carriers, each having a bandwidth of 5 MHz. For reasons of economy, all of the modulated carriers of a base station are transmitted by means of a single amplifier. In the example shown in FIG. 1 there are three adjacent carrier bands f₁, f₂, f₃.

The powers allocated to the carriers can be significantly different.

Thus, in this embodiment, the carrier f₁ has the highest power and the carrier f₂ has the lowest power. Each of these carriers corresponds to a 5 MHz wide frequency band.

In the prior art, in the above kind of situation, a clipped power average statistical density is used that is constant for the three bands f₁, f₂, f₃; in other words, a filter is used which limits the amplitudes of the signals in the bands f₁, f₂ and f₃ to the same value M.

The density M being the same for the three bands, which have different amplitudes, the signal-to-noise ratios are therefore different. It can therefore be seen that the signal-to-noise ratio for the carrier f, is significantly higher than that for the carrier f₂.

According to a first aspect of the invention, the clipping applied to each carrier is a function of its power. Accordingly, in the embodiment shown in FIG. 1, the clipped power average statistical density ml for the carrier f₁ is the highest and the corresponding density m₂ for the carrier f₂ is the lowest. In other words, for the purposes of clipping, a filter characteristic 10 is chosen that corresponds to that of the input signal f₁, f₂, f₃. This minimizes the distortion for the weakest carriers and, since the clipped power average statistical density varies with the input signal, the density can be optimized at all times. It can be seen in FIG. 1 that the highest density m₁ is lower than the density M of the prior art technique. The rating of the amplifier can be less severe if the clipped power mean statistical density is optimized.

In accordance with another aspect of the invention, which can be used independently of the first aspect, the average clipping radius varies with the total power of the input signal and the power margin (i.e. the difference, in dB, between the saturation power and the average operating power) of the amplifier varies with the total power of the signal.

In a simplified embodiment in which the amplifier transmits three or four carrier bands, the lowest power carrier is detected and allocated a filter producing the lowest clipping power density, and the same power density is allocated to the other two (or three) carrier bands. In this case, adaptive filtering necessitates a choice between only a limited number of filters. Furthermore, the results obtained with this embodiment are substantially the same as those obtained when the clipping filter exactly reflects the input signals.

This example of filtering is represented in FIG. 1a, in which it can be seen that the filter characteristic has two clipping power densities m′₁ and m′₂, the density m′₁ is allocated to the carriers f₁ and f₂ and the density m′₂ is allocated to the lowest amplitude carrier f₃.

According to a further aspect of the invention, the guard bands between the carrier frequency bands f₁, f₂ and f₃ are used to reject in these bands any residual distortion in the wanted band, which would therefore make a weak contribution to the distortion of the carriers. It can thus be seen in FIG. 1 that the filter has a lower attenuation 12 between the clipping power densities m₁ and m₂ and, likewise, the filter also has a lower attenuation 14 between the bands f₂ and f₃.

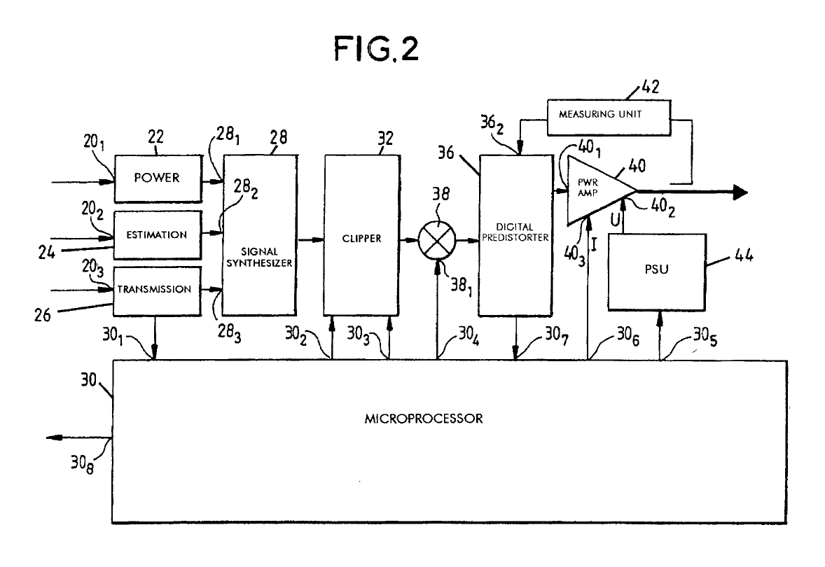

FIG. 2 shows in the form of a block diagram a base station using the method according to the invention.

As in the FIG. 1 embodiment, this base station is adapted to transmit three adjacent frequency bands f₁, f₂ and f₃. The modulated carriers f₁, f₂ and f₃, i.e. the symbols to which codes are allocated, are applied to respective inputs 201, 202 and 203 of respective power estimation and transmission devices 22, 24 and 26.

The device 22 transmits the input signal f₁ to a first input 28₁ of a device 28 for synthesizing or composing signals on different carriers. Likewise, the output of the device 24 is connected to the second input 28₂ of the device 28 and the output of the device 26 is connected to the third input 28₃ of the device 28.

The power estimates provided by the devices 22, 24 and 26 are applied to an input 30₁ of a microprocessor 30.

The device 28 provides at its output 28₄ a composite signal which is applied to the input of a clipping unit 32 which applies the filter characteristic 10 shown in FIG. 1. The data for applying this filter characteristic is supplied by two outputs 30₂ and 30₃ of the microprocessor.

The output 30₂ determines the clipping threshold of the composite signal from the sum of the powers P1, P2 and P3 of the respective carriers f₁, f₂ and f₃, i.e. from the signal applied to the input 30₁ of the microprocessor 30.

The output 30₃ supplies the filter characteristic 10. This complies with the proportional relationship between carriers to maintain a similar distortion on each carrier; thus a tuned filter is obtained, so to speak.

The output of the unit 32 is connected to the input of a digital predistortion unit 36 via a variable gain component 38. The variable gain component 38 has a clipping gain control input 38₁ which is connected to an output 30₄ of the microprocessor 30. The signal delivered by the output 30₄ controls the gain as a function of the clipping radius and the total power, i.e. the sum of the powers P1, P2 and P3. This gain is such that the amplitude of the output signal of the component 38 is practically equal to the amplitude of the signal at the input of the unit 32. This gain is a relatively simple function, which can be tabulated.

The output of the digital predistortion unit 36 is connected to the input 40₁ of the power amplifier 40 to be linearized. The unit 36 has a second input 36₂ which, for learning mode adaptive digital predistortion by a measurement receiver, conventionally receives, via a measuring component 42, data for updating the predistortion tables coming from the output of the amplifier 40.

The amplifier 40 has two power supply inputs 40₂ and 40₃; the first input 40₂ is connected to the output of a power supply unit 44 which supplies a voltage determined by an output 30₅ of the microprocessor 30. The second input 40₃ receives a control signal from an output 30₆ of the microprocessor 30, this signal determining the bias current for the gates of the transistors. The control signals applied to the inputs 40₃ and 40₂ both depend on the total power P1+P2+P3.

In this embodiment, the predistortion coefficients are computed and updated in the unit 36 by comparing the output signal of the unit 38 and the signal from the receiver 42 at the input 36₂. The unit 36 has an output connected to an input 30₇ of the microprocessor. The latter therefore monitors the state of convergence of the predistortion tables. This state of convergence conditions the rate of change of the operating point of the amplifier 40 by the control signals from the outputs 30₅ and 30₆ (see below).

Finally, the microprocessor 30 has an output 30₈ supplying to the telecommunication system an indication of the power that the amplifier 40 can still accept. This instantaneous acceptable power is related to the difference between the current saturation point of the amplifier and the current clipping radius (see below). It corresponds totally or partially to a margin at the saturation point of the amplifier relative to the current power.

Operation is as follows:

The units 22, 24 and 26 estimate the power on each of the carriers f₁, f₂ and f₃. To this end, the units 22, 24 and 26 sum the powers of the successive samples (individual bits) over at least one symbol, preferably the longest symbol, i.e. over 256 samples, and over a time period less than a time slot. In the case of the UMTS standard, the frequency of appearance of the individual bits (i.e. the chosen sampling frequency in this embodiment) is 3.84 MHz. This estimate is therefore effected for each time slot over a horizon from 33 μs to 666 μs and is repeated at intervals of 666 μs.

By selecting a symbol in each time slot, power variations on each carrier can be detected quickly.

From the powers P1, P2 and P3 estimated in each time slot, the microprocessor 30 determines, firstly, the clipping radius and, secondly, the filter characteristic 10 (FIG. 1) for the three carriers concerned. The simplified method shown in FIG. 1a can equally well be used.

In one embodiment, the microprocessor 30 holds in memory a set of filters and the filters are chosen as a function of predetermined tables. These predefined tables are determined either by computation or empirically.

Experience shows that with three carriers, or at the most four carriers, only a limited number of filters has to be stored in memory for a maximum contrast of 18 dB between the powers of the carriers, for example. Thus around ten filters can be sufficient for three carriers, each filter having a maximum of 32 to 256 complex coefficients in the case of finite impulse response filters.

The clipping radius or threshold, which is computed in each time slot on the basis of the sum of the carrier powers P1, P2 and P3, has a value approximately +4 dB greater than the total power when there are three UMTS carriers, for example.

Control signals applied to the inputs 40₂ and 40₃ of the amplifier 40 adjust the characteristics of the amplifier so that its efficiency remains high. In this embodiment, the microprocessor 30 holds in memory tables for adjusting the value I of the current i applied to the input 40₃ and the voltage U applied to the input 40₂ so that the 1 dB compression point remains close to the clipping circle, to maintain correct predistortion efficacy and convergence, at the same time as the correct efficiency. Like any looped or adaptive system, convergence refers to the stable state in which, after a number of iterations (the convergence time), the values from the predistortion table are no longer modified (ignoring loop noise) and yield the best representation of the inverse transfer function of the amplifier, which minimizes the spectral difference between the input signal and the output signal of the linearized amplifier.

It will also be remembered that the 1 dB compression point is the operating point for strong signals (in the vicinity of the clipping radius), for which the gain is 1 dB less than the gain in the linear region.

The time constants of the various units of the station shown in FIG. 2 are not all the same. Accordingly, the power estimates produced in the devices 22 to 26 have time constants of the order of 1 microsecond to 100 microseconds, the time constants of the digital predistortion unit 36 are of the order of one tenth of a millisecond to a few milliseconds, and the adjustment time constants of the parameters I and U are from one millisecond to one second, or even more, i.e. one minute. This is because these parameters I and U cannot vary too quickly because they must allow adaptation of the predistortion coefficients. In other words, the rate of variation of the parameters I and U must be sufficiently low to be able to carry out the computation for updating the predistortion tables.

In a preferred embodiment, the amplifier voltage is controlled with hysteresis so that the decrease in the voltage is slower than the increase in the voltage so that, in the event of a fast increase in the power of one of the carriers, the amplifier can retain a sufficient power margin with valid predistortion tables.

In other words, this hysteresis behavior must be, such that it is possible to absorb additional users without disruption before having to raise the operating point. Accordingly, the saturation point of the amplifier must be such that the corresponding clipping radius can adapt to a demand for additional power for a few users.

For example, in the case of a power amplifier able to transmit 30 watts (i.e. three carriers of 10 watts), the margin can be of the order of 2 watts. Accordingly, before increasing the voltage U of the amplifier, the latter has the benefit of a margin of 2 watts that can be used to absorb additional demand. Accordingly, regardless of the instantaneous clipping radius, the biasing of the amplifier will still be effective 2 watts higher, i.e., in this example, when the maximum of 28 watts is reached, and never falls below 4 watts, even if no call is active (2 watts margin and approximately 2 watts for sending common channels of each carrier or cell). The average efficiency over a day is still high because the average power in slack periods can be ten times smaller than the average power at busy times.

To combine convergence of the digital predistortion signals with adaptation of the characteristics of the amplifier, it is necessary to use fast digital predistortion algorithms with convergence times from 100 microseconds to a few milliseconds. Least mean square (LMS) algorithms are therefore used.

Looping in the time domain (as opposed to the frequency domain) can also be used. On this subject, it will be remembered that the most recent adaptive digital predistortion methods can use two different approaches to learning and updating the tables:

Either by comparing in real time, using a broadband receiver, each signal sample sent by the amplifier to each sample that it is required to send (at the output of the unit 38): this is looping in the time domain and is used in this example because of its speed.

Or by comparing the spectrum of the output signal of the unit 38 with the spectrum sent, which is periodically analyzed for each sub-band by means of a narrowband receiver that sweeps the send band. This is looping in the frequency domain and converges more slowly but is less costly.

The processing power needed for the microprocessor 30 is relatively low when using adaptation parameters that are precomputed or predetermined in the form of tables.

In the case of application of the UMTS mobile telephone standard, the accuracy of power control is maintained for all of the carriers (according to the license allocation schemes, the maximum number of carriers is four), whereas the composite signal has a peak power to average power ratio of 4 dB for three carriers and the efficiency can exceed the maximum output power by 15%, although for conventional base stations this efficiency is from 5% to 8%.

Furthermore, thanks to adaptive clipping filters, it is possible to tolerate a high contrast between the carriers without compromising the optimum operation of the station. Thus one carrier can be fully “loaded” and another carrier not loaded, i.e. transmit only signaling. It is equally possible to use the same amplifier for two concentric cells, i.e. a cell having a relatively wide coverage and another cell of significantly smaller radius but supporting heavy traffic.

Moreover, varying the amplifier supply voltage U and varying the power margin for adapting these parameters to the specific application can reduce power consumption by a factor of about two. This also improves the reliability of the power amplifier and therefore of the base station using the amplifier.

The computed power margin can be used for the transmitted power monitoring algorithms. This is because, if the CDMA technique is used (and thus in the UMTS), to obtain sufficient capacity it is essential to minimize interference induced in the cell and in other cells. To achieve this, in each time slot (666 μs), the power transmitted to and by each user (code) must be redefined in a controlled and accurate manner in order to send only the power strictly necessary, to within better than 1 dB, or even 0.5 dB, as a function of the quality of service negotiated with the mobile.

Although the foregoing description relates to the use of the invention in the context of CDMA transmission, the invention is not limited to that application. It can equally well be used for TDMA transmission on a plurality of carriers.

The invention applies primarily to a base station of a telecommunication system. It can nevertheless apply to a terminal having to send simultaneously on a plurality of carriers.

There is claimed:

1. A method of transmitting a plurality of carriers using the same power amplifier associated with linearization means, in which method a composite signal comprising said plurality of carriers is clipped before it is applied to the input of said amplifier in order to limit the ratio of the peak power to the average power of the signal to be transmitted, each carrier is clipped individually, and the clipping power density for each carrier is a function of its power.

2. The method claimed in claim 1 wherein said clipping is effected by adaptive filtering with a spectral characteristic that reproduces the spectrum of said signal to be transmitted.

3. The method claimed in claim 1 wherein there is lower attenuation between adjacent bands.

4. The method claimed in claim 1 wherein the carrier with the lowest power is determined, that carrier is allocated a first clipping spectral density threshold, and the other carriers are allocated a second clipping spectral density threshold higher than the first.

5. The method claimed in claim 1 wherein the clipping spectral density levels are chosen from sets previously stored in memory, in particular sets of filters.

6. The method claimed in claim 1 wherein the signals to be transmitted modulating said carriers are CDMA signals and the power of each carrier is estimated over at least one symbol during each time slot.

7. The method claimed in claim 6 wherein each carrier is estimated over the longest symbol of the time slot.

8. The method claimed in claim 6 wherein the power is estimated for each coding sample of the symbol for which the estimate is effected.

9. The method claimed in claim 1 wherein said carrier bands transmit time division multiplexed signals.

10. The method claimed in claim 1 including gain compensation to obtain at the input of said amplifier a signal having practically the same amplitude as said composite signal despite gain variations caused by said clipping.

11. The method claimed in claim 1 wherein said carriers are in adjacent bands.

12. Application of a method as claimed in claim 1 to a base station of a telecommunication system.

13. Application of a method as claimed in claim 1 to a terminal of a telecommunication system.
